(19) United States
(12) Patent Application Publication
(10) Pub. No.: US 2008/0089221 A1
(43) Pub. Date: Apr. 17, 2008

(54) Method For Realizing Link Adaptation In Mimo-Ofdm Transmission System

(76) Inventors: Karsten Bruninghaus, Salzgitter (DE); Uwe Schwark, Achim (DE)

Correspondence Address: STAAS & HALSEY LLP, SUITE 700, 1201 NEW YORK AVENUE, N.W., WASHINGTON, DC, 20005, US

(21) Appl. No.: 11/664,252

(22) PCT Filed: Sep. 30, 2005
(86) PCT No.: PCT/EP05/54933

§ 371 Date: Mar. 30, 2007

(30) Foreign Application Priority Data
Sep. 30, 2004 (DE) 10 2004 047 746.9

(51) Int. Cl. H04L 27/26; H04L 1/00; H04L 1/16; H04L 7/04; H04L 25/02

(52) U.S. Cl. 370/203; 375/299

(57) ABSTRACT

A postamble structure is immediately attached to a data block that does not contain sufficient information with regard to channel identification. This postamble structure has, for each antenna, a channel estimation section with a channel estimation sequence. A transmission mode in a respective station is selected based on of the received channel sequence.

### CROSS REFERENCE TO RELATED APPLICATIONS

This application is based on and hereby claims priority to German Application No. 10 2004 047 746.9 filed on Sep. 30, 2004, the contents of which are hereby incorporated by reference.

### BACKGROUND

Described below is a method for realizing a link adaptation in a MIMO-OFDM (Multiple Input Multiple Output-Orthogonal Frequency Division Multiplexing) transmission system, and especially to a multi-antenna system, which can be used in future high bit-rate WLANs (Wireless Local Area Network), but also in mobile radio systems with multi-antenna technology.

Known wireless OFDM transmission systems, as used for example in WLANs, usually employ only one antenna in the transmitter and/or receiver.

By contrast, MIMO-OFDM transmission systems (MIMO, Multiple Input Multiple Output) represent an innovative expansion, which, depending on the channel properties, makes possible a significant increase in spectral efficiency through spatial “multiplexing”. However such multi-antenna systems can only be utilized to their full capabilities if a transmission channel to be used is known a-priori, i.e. in advance, in the transmitter. This information, or so-celled short-term channel knowledge, namely forms the basis for a link adaptation in a transmission system, since it enables the physical transmission parameters or a transmission mode of a respective station to be adapted to the channel characteristics in the optimum manner, so that the maximum achievable data rate of the data bits able to be transmitted without errors comes as close to the theoretical channel capacity as possible.

Publication WO 02/082751 describes a method for realizing a link adaptation in an OFDM transmission system, in which only one antenna is used in the transmitter and/or receiver.

### SUMMARY

By contrast an underlying aspect of the method described below is realizing a link adaptation in a MIMO-OFDM transmission system as well, i.e., in a multi-antenna system, with the adaptation allowing maximum efficiency as well as physical downwards compatibility to stations or transmission systems which already exist.

Especially by directly appending a postamble structure to a data block which does not have sufficient information for MIMO channel identification, with the postamble structure featuring a channel estimation section with a channel estimation sequence for each antenna, and a transmission mode being selected in a respective station on the basis of the received channel estimation sequence, a short-term channel knowledge can be determined with a reduced overhead and thereby a link adaptation to the prevailing environmental conditions made possible. In particular however this produces a physical downwards compatibility to existing transmit/receive stations, since the postamble structures are appended directly to a data block which is present in the signaling in any event.

A further postamble structure is preferably defined on the basis of the received channel estimation sequence of the postamble structure and is appended chronologically directly after a further data block, with the further postamble structure featuring for each antenna a signaling section with a signaling sequence for signaling the selected transmission mode and a further channel estimation section with a further channel estimation sequence, with a further adapted transmission mode being selected on the basis of the received further channel estimation sequence and/or of the signaled transmission mode. The short-term channel knowledge can be further improved in this way, which further increases an achievable data rate of the payload data bits to be transmitted without errors.

For example the further transmission mode is equal to the signaled transmission mode. Because of this binding assignment a signaling overhead is minimal.

Alternatively however the further transmission mode can be further modified in relation to the signaled transmission mode, with a link adaptation for example being able to be further optimized from knowledge of local environmental conditions. Although a transmission mode modified in this way can be signaled back in its entirety, preferably only the transmission mode modification is signaled back, which allows efficiency during transmission to be further improved.

Where the further postamble structure is used the signaling section can be transmitted chronologically before or after the further channel estimation section, in which case, especially if the signaling section prior to the channel estimation section is used and if a binding use is made of the transmission modes, i.e. the further transmission mode is equal to the signaled transmission mode, the length of the signaling section as well as the length of the channel estimation section can be explicitly transmitted and thereby the detection security increased.

Preferably the channel estimation sequences of the postamble structure are transmitted consecutively at each antenna.

The channel estimation sequence of the further postamble structure for the relevant antennas preferably contains a concatenation of the OFDM symbols according to

$${c}_{m} ( n ) = {g}_{m , 1} ( n ) \underbrace{{c}_{m , 1} ( n ) … {c}_{m , 1} ( n )}_{j} {g}_{m , 2} ( n ) \underbrace{{c}_{m , 2} ( n ) … {c}_{m , 2} ( n )}_{j} … {g}_{m , D} ( n ) \underbrace{{c}_{m , D} ( n ) … {c}_{m , D} ( n )}_{j}$$

with
c_{m,d}(n)=DFT⁻¹{C_{m,d}(k)} mit C_{m,d}(k)=u*_{k,m,d}·C(k)
with C(k) representing a basic channel estimation signal in the frequency range, m=1, . . . , M_{R} or M_{T} an antenna index, M_{R} and M_{T} a number of receive and transmit antennas, d=1, . . . , D an index of the spatial data stream, D the maximum number of spatial data streams across all subcarriers

$$D = {max }_{∀ k} {D}_{k} ,$$

n=1, . . . , N a sampling index, N the number of the sampling values per OFDM symbol, g_{m,d}(n) a guard interval sequence of a guard time interval, k a subcarrier index, j the number of repetitions of the OFDM symbols c_{m,d}(n) and u*_{k,m,d} a conjugated complex mth column and dth row element of the left singular matrix Uₖ.

When transmission channels which are reciprocal and sufficiently time-invariant are used, this especially produces simplifications and an increased accuracy in the link adaptation.

Preferably the method is executed in an OFDM transmission system in accordance with the IEEE 802.11 Standard and especially within an RTS-/CTS signaling or data polling mechanism. The efficiency of existing WLAN communication systems can be improved retroactively in this way.

### BRIEF DESCRIPTION OF THE DRAWINGS

These and other objects and advantages will become more apparent and more readily appreciated from the following description of exemplary embodiments, taken in conjunction with the accompanying drawings of which:

FIG. 1 is a simplified data frame structure for RTS/CTS data exchange according to the IEEE 802.11 Standard;

FIG. 2 is a simplified data frame structure for the modified RTS/CTS data exchange according to a first exemplary embodiment;

FIG. 3 is a simplified data frame structure for illustrating a channel estimation section;

FIG. 4 is a simplified data frame structure for illustrating a postamble structure with channel estimation sections in a multi-antenna system;

FIG. 5 is a simplified data frame structure for illustrating a further postamble structure with a further channel estimation section and a signaling section in a multi-antenna system;

FIG. 6 is a simplified data frame structure for an RTS/CTS data exchange according to a second exemplary embodiment;

FIG. 7 is a simplified data frame structure for a data polling mechanism according to a third exemplary embodiment; and

FIG. 8 is a simplified data frame structure for a data polling mechanism according to a fourth exemplary embodiment.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The method described below is based on a WLAN (Wireless Local Area Network) transmission system according to the IEEE 802.11 Standard as an OFDM transmission system, but with alternate OFDM transmission systems also basically being conceivable however. According to this IEEE 802.11 Standard, to which explicit reference is made at this point, OFDM symbols are used in an OFDM (Orthogonal frequency Division Multiplexing) transmission system. This type of multiplexing method is especially suitable for heavily disturbed terrestrial transmissions of digital radio signals, since it is insensitive to echoes.

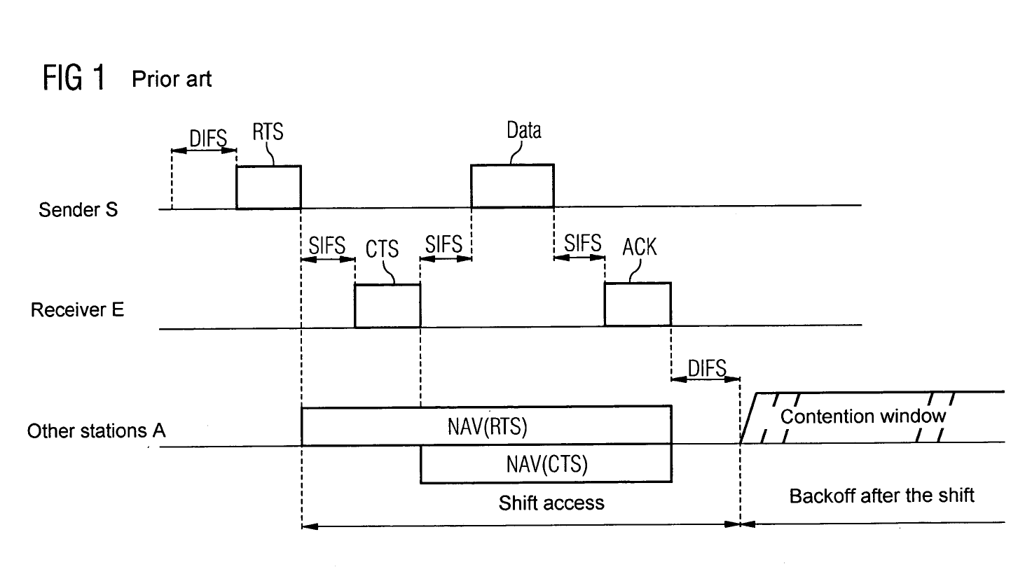

To illustrate a preferred area of application of the method, the conventional RTS/CTS data exchange of the local carrier frequency multiple access detection system DCF (Distributed Coordination Function) according to Standard IEEE 802.11 will first be described. As regards the meaning and functionality of the terms and abbreviations shown in FIG. 1, the reader is referred to the supplementary information relating to definition of terminology in the Standard.

In accordance with FIG. 1, after a first guard time DIFS (DCF Interframe Space) from a transmitter S to the network or the other stations of the communication system, an RTS (Ready To Send) signal is transmitted. With regard to the structure of this RTS signal, the reader is again referred to the Standard. Within the Ready to Send signal RTS there is what is known as a “duration” block, which makes it possible to reserve a current right to send with a predetermined duration. After a short second guard time SIFS (Short Interframe Space) the receive station or the receiver E selected by the send station or by the transmitter S, in order to indicate a readiness to receive, sends a CTS (Clear To Send) signal in which once more a so-called “duration” block defines a reservation of a current right to send with a predetermined duration on the receiver side. After a further short interframe space SIFS the send station S sends payload data packet Data from the send station S to the receive station E. After the transmission of the data in the data packet Data, after a further second short interframe space SIFS the receipt of the payload data packet Data is acknowledged by the receive station E by an acknowledgement signal ACK (Acknowledge). According to Standard IEEE 802.11 the first and second short interframe spaces SIFS and DIFS amount to 16 microseconds and 34 microseconds respectively.

In this case the time values contained especially in the “duration” blocks of the ready to send and clear to send signals RTS and CTS set in the other stations A of the communication network within range of the transmit or receive station S and E what is known as an NAV (Network Allocation Vector) which specifies for how long no transmission can be undertaken on the radio medium or the transmission medium by the relevant station. In more precise terms the further stations A which are within “hearing” distance are forbidden to send for the period defined in the “duration” block. Access to the communication system or to the transmission medium is only possible once again after a further first DCF Interframe Space DIFS has elapsed after transmission of the acknowledgement signal ACK by the receive station E. In the subsequent contention window, in order to avoid a collision, a further delay by a random “backoff” time occurs.

In multi-antenna systems, whereby a respective station of the communication network has a plurality of antennas, a full performance capability can only be achieved if a transmission channel to be used is known “a-priori” i.e. in advance in the send station S. This type of information is usually also referred to as a short-term channel knowledge. As regards the terms send station and receive station used here, it should be pointed out that these stations essentially relate to sending and receiving payload data and not to sending or receiving for example the signaling blocks RTS, CTS and ACK. As can be seen from FIG. 1, although as a result the send station S sends the payload data Data, however it also receives the signaling data CTS and ACK from the receive station E.

Before the exemplary embodiments with their respective postamble structures are explained below, the abbreviations used will first be defined:
G: Guard interval
GG: Double-length guard interval
DFT: Discrete Fourier Transformation
DFT⁻¹: Inverse Discrete Fourier Transformation
OFDM: Orthogonal Frequency Division Multiplexing
M_{T}: Number of transmit antennas
M_{R}: Number of receive antennas
n: Time index (=sample value)
mᵣ, mₜ: Receive and transmit antenna indices
x: Further antenna index
d: Index of the spatial data stream
fₖ: Frequency of the kth subcarrier
k: Subcarrier index (=frequency index; requires: OFDM-based transmission system)
N: Number of sample values per OFDM symbol (depends on the D/A or A/D converter rate)
Dₖ: Number of spatial data streams transmitted on the kth subcarrier
D: Maximum number of spatial data streams across all subcarriers,

$$D = {max}_{∀ k} {D}_{k}$$
c_{m,d}(n): dth channel estimation sequence (=signal sequence for supporting channel estimation in the receiver) for the further postamble structure P2, which will be transmitted via antenna m
c_{m,x}(n): xth channel estimation sequence (=signal sequence for supporting channel estimation in the receiver) for the further postamble structure P1, which will be transmitted via antenna
C(k): Basic channel estimation signal in the frequency range
C_{m,d}(k): dth channel estimation signal in the frequency range for the further postamble structure P2 which will be transmitted via antenna m
C_{m,x}(k): xth channel estimation signal in the frequency range for the postamble structure P1, which will be transmitted via antenna m
I_{T,k}: Vector with data symbols which will be transmitted on the kth subcarrier.
x_{T,k}: Send signal vector (in the frequency range) on the kth subcarrier
y_{R,k},y_{T,k}: Receive signal vector (in the frequency range, without noise) on the kth subcarrier
Hₖ: Channel matrix of the kth subcarrier
H_{k,m}_{ᵣ}_{,m}_{ₜ}: mᵣth row and mₜth column element of channel matrix Hₖ. Corresponds to the complex transmission factor between the mᵣth receive and mₜth send antenna.
u_{k,d}: dth left singular vector of matrix Hₖ
u_{k,m,d}: mth row and dth column element of the matrix Uₖ
Uₖ: Matrix with left singular vectors=left singular matrix
Ũₖ: Hypothetical equalization matrix in the receiver=part matrix of Uₖ consisting of Dₖ≦M_{R} left singular vectors
v_{k,d}: dth right singular vector of the matrix Hₖ
Vₖ: Matrix with right singular vectors=right singular matrix
\tilde{V}ₖ: Equalization matrix in the transmitter=part matrix of Vₖ consisting of Dₖ≦M_{T} right singular vectors
s_{k,d}: singular values of matrix Hₖ
Sₖ: Matrix with the singular values s_{k,d} on a diagonal
\tilde{S}ₖ: Resulting transmission matrix (with use of Ũₖ in the transmitter and \tilde{V}ₖ in the receiver)
(•)^{H}: Hermitic
(•)*: Conjugated complex
[•]_{A×B}: indicates the dimension of a matrix: A=number of rows, B=number of columns
   Remarks:
The subscripted T indicates that station sending or wishing to send payload data and the subscripted R indicates that station receiving or intended to receive payload data.
What are referred to here as a “sequence” are the sampled values of an OFDM symbol, i.e. n=1, . . . , N

As has already been pointed out at the beginning of this document, a high efficiency of a multi-antenna system, especially in conjunction with OFDM transmission technology can only be achieved if the channel matrices

$${[ {H}_{k} ]}_{{M}_{R} \times {M}_{T}} = [ \begin{matrix}{H}_{k , 1 , 1} & {H}_{k , 1 , 2} & … & {H}_{k , 1 , {M}_{T}} \\ {H}_{k , 2 , 1} & {H}_{k , 2 , 2} & … & {H}_{k , 2 , {M}_{T}} \\ … & … & … & … \\ {H}_{k , {M}_{R} , 1} & {H}_{k , {M}_{R} , 2} & … & {H}_{k , {M}_{R} , {M}_{T}}\end{matrix} ]$$

are known for each subcarrier k, with the complex factor H_{k,m}_{_{R}}_{,m}_{_{T}} in this case describing the attenuation and phase shift of a frequency fₖ of the transmit antenna mₜ to receive antenna mᵣ. Accordingly M_{T} describes a number of transmit antennas and M_{R} a number of receive antennas. According to the described method the short-term channel knowledge in the transmitter should thus be able to be determined reliably and with as little overhead as possible. This information forms the basis for an adaptation of the physical transmission parameters or of the respective transmission mode to be employed, so that an achievable data rate of the data bits to be transmitted without errors comes as close as possible to the theoretical channel capacity.

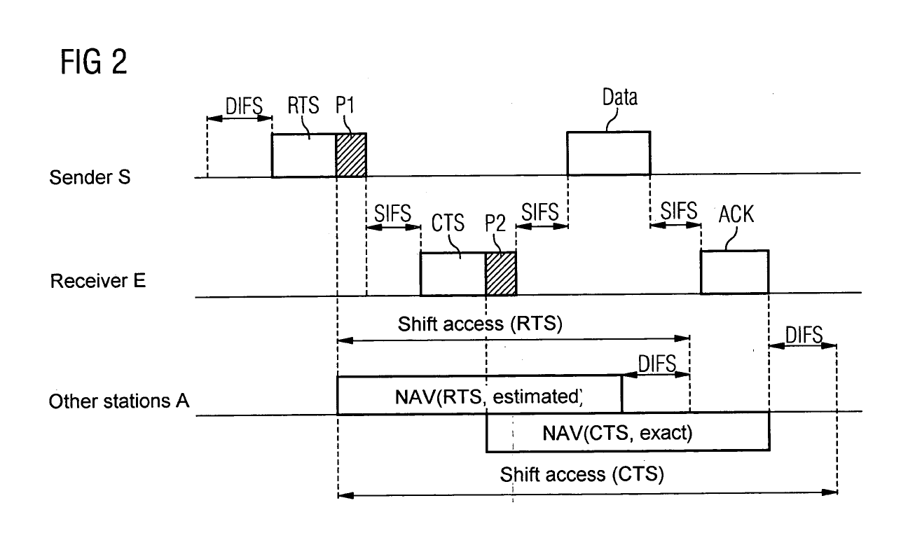

Since the conventional RTS/CTS signaling shown in FIG. 1 occurs immediately before an actual data transmission, this mechanism can also be employed very efficiently for contemporaneous channel identification and for link adaptation. In this case to achieve a simultaneous downwards compatibility to existing stations or systems the modifications shown in FIG. 2 are proposed.

FIG. 2 shows a simplified data frame structure for the RTS/CTS data exchange of a locally organized carrier frequency multiple access system (DCF) according to a first exemplary embodiment, with the same reference symbols identifying the same or corresponding data blocks or elements as shown in FIG. 1 and such elements not being subsequently described once again below.

To realize a link adaptation in a MIMO-OFDM transmission system, in which respective stations have a plurality of antennas, a data block in a send station S which does not have sufficient information for MIMO channel identification can as a result have a postamable structure P1 appended chronologically directly after it which features a channel estimation section for each antenna with a channel estimation sequence, with an adapted transmission mode in a respective station being selected on the basis of the received channel estimation sequence.

In addition, according to FIG. 2, on the basis of the received channel estimation sequence of the postamble structure P1 e.g. in the receive station E, a further postamble structure P2 can be defined and a further data block, which only has unsatisfactory or no sufficient information for MIMO channel identification, can be chronologically directly appended, with the further postamble structure P2 featuring for each antenna a signaling section with a signaling sequence for signaling the selected transmission mode and a further channel estimation section with a further channel estimation sequence, with a further transmission mode being selected in the send station S on the basis of the received further channel estimation sequence and/or of the signaled transmission mode and subsequently the payload data DATA being transmitted with a maximum achievable data rate of data bits to be transmitted without errors.

In more precise terms, in accordance with FIG. 2, a postamble structure P1 for MIMO channel identification is appended in the send station S chronologically directly after the transmission of the ready to send signal RTS. After the second short interframe space SIFS elapses, a clear to send signal CTS is sent by the receive station E and a further postamble structure P2 is appended chronologically directly thereafter which signals both the “most effective” transmission mode (encoding, number of parallel data streams per subcarrier as well as their modulation, type of MIMO preprocessing e.g. SVD or V-Blast) as seen by the receive station E in a signaling section and also sends suitable further pilot symbols or a further suitable channel estimation sequence for determining the preprocessing matrices in the send station S. It is assumed in this case that the transmission channel is reciprocal, i.e. its channel properties are dependent on each other as regards its transmission direction.

As regards an actual transmission mode or the physical transmission parameters employed, two variants can basically be identified:
a) The send station S is obliged to use the transmission mode predetermined or signaled by the receive station E as a component of the clear to send signal CTS. This means that the further transmission mode used in the send station S is the same as the transmission mode signaled by the further postamble structure P2. In this case a repetition of the return signaling within for example the payload data packet Data can be omitted, which allows a signaling overhead to be limited.
b) On the other hand the send station S can further modify the transmission mode selected by the receive station E, as predetermined in the signaling field of the further postamble structure P2. In this case return signaling of the current newly set further transmission mode in the send station S is a mandatory requirement. For reasons of efficiency it can be worthwhile, provided the degree of freedom of modifying the transmission mode in this way exists, to only signal the transmission mode change in relation to the transmission mode proposed by the receive station E.

The direct chronological appending of the postambles P1 and P2 to the ready to send signal RTS as well as to the clear to send signal CTS is largely transparent for conventional 802.11a as well as 802.11g devices with only a single antenna, which produces an advantageous physical downwards compatibility to existing stations or systems. As a result not only can increased efficiency be achieved with the method but in addition a downwards compatibility to conventional systems can also be realized.

Since the send station S cannot make any prediction about the duration of payload data packet Data in the RTS signaling in the absence of information about the transmission mode n to be used, an “optimistic estimation” is to be undertaken in the initialization of the so-called “duration” block within the ready to send signal RTS, from which the network access vector NAV will later be derived, which is certain to be less than or equal to the actual duration of a payload data packet Data to be sent. This is for example possible by assuming the maximum physical data rate.

Such a process is non-critical to some extent since interference is avoided by the carrier sense multiple access method with collision avoidance (CSMA) employed. Since the other stations A depicted in FIG. 2 merely wake up earlier than necessary, it is only power saving options which are not exploited to the full in this case.

With CTS signaling the network access vector NAV can then be set “exactly” or directly in the receive station E on the other hand, provided the send station S is obliged to actually use the transmission mode selected and defined by the receive station E. Furthermore it must also be known to the receive station E for this purpose how many data bits the send station S wishes to transmit. This information can either be transmitted as a component of the postamble structure P1 or can also be derived implicitly from the “duration” block. If as a result the assumed hypothetical data rate in the send station S is known to the receive station E, the method can be designed more effectively as a result.

It is also true however that an exact initialization of the “duration” block within the clear to send signal CTS is not an absolute necessity. Initialization with a value which is too low however conceals the danger of collisions through so-called “hidden nodes”. For this reason the value of the clear to send signal CTS entered in the “duration” block, should in preference be chosen as a pessimistic value, i.e. too small, if it cannot be specified exactly.

The use of RTS/CTS signaling for link adaptation shown in FIG. 2 should ideally be employed adaptively. This means that whenever a data connection between two stations was relatively far back in time (for example in relation to the coherence time of the channel) and consequently the channel information is outdated, a new RTS/CTS signaling in the described form is used to refresh the channel information. On the other hand the corresponding signaling is dispensed with, if it is not provided in any event to avoid the so-called “hidden nodes”. In this context the reader is also referred to the operational settings in accordance with IEEE 802.11.

A further criterion for the use of the RTS/CTS data exchange for link adaptation should also be the length of the payload data packet Data to be transmitted. The additional signaling overhead is counterproductive with short payload data packets Data and should therefore be avoided even if it enables the actual data transmission to be designed more efficiently.

Variants for the postamble P1 and the further postamble P2 are described below. The starting points in this case are the channel estimation sections made available within the IEEE 802.11 Standard as part of preamble structures.

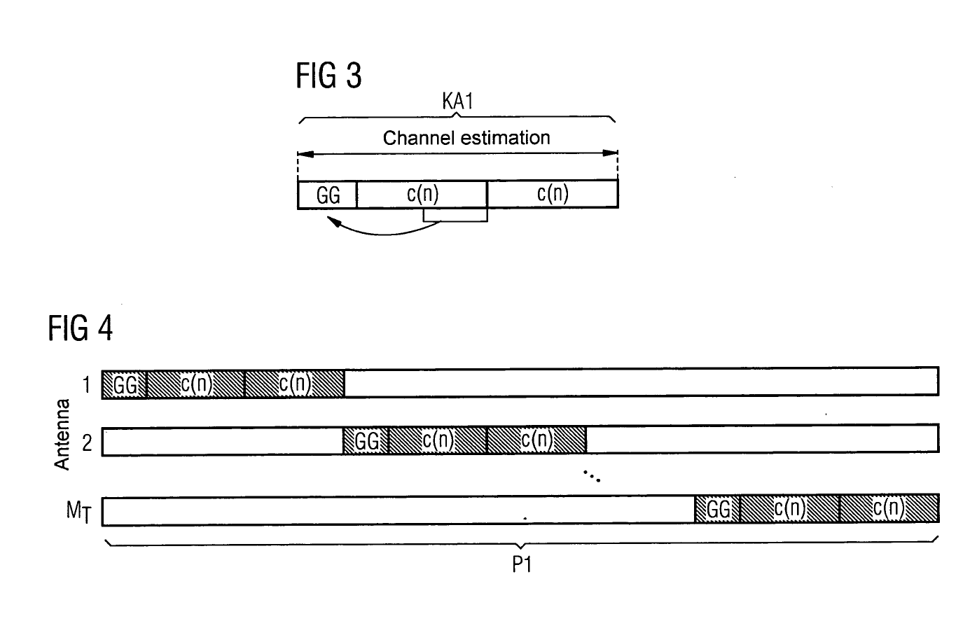

FIG. 3 shows a channel estimation section KA1 with a channel estimation sequence c(n), as is preferably used in a postamble P1. The arrangement of these channel estimation sections KA1 in relation to the plurality of antennas 1 to M_{T} is shown in FIG. 4, with the channel estimation section with its channel estimation sequence being transmitted in turn on each antenna 1 to M_{T}.

The channel estimation sequence of the postamble structure P1 is produced as a result for the respective antennas 1 to M_{T} from a concatenation of the OFDM symbols in accordance with

$${c}_{m} ( n ) = {g}_{m , 1} ( n ) \underbrace{{c}_{m , 1} ( n ) … {c}_{m , 1} ( n )}_{j} {g}_{m , 2} ( n ) \underbrace{{c}_{m , 2} ( n ) … {c}_{m , 2} ( n )}_{j} … {g}_{m , D} ( n ) \underbrace{{c}_{m , {M}_{T}} ( n ) … {c}_{m , {M}_{T}} ( n )}_{j}$$

$$with$$

$${c}_{m , x} ( n ) = {DFT}^{- 1} \{ {C}_{m , x} ( k ) \} und {C}_{m , x} ( k ) = \{ \begin{matrix}C ( k ) & x = m \\ 0 & sonst\end{matrix} n = 1 , … , N$$

with C(k) representing a basic channel estimation signal in the frequency range, m=1 . . . , M_{T} an antenna index, M_{T} a number of transmit antennas, x any given run index, d=1, . . . , D an index of the spatial data stream, D the maximum number of the spatial data streams over all subcarriers

$$D = {max }_{∀ k} {D}_{k} ,$$

n=1, . . . , N a sampling index, N the number of the sampled values per OFDM symbol, g_{m,x}(n) a guard interval sequence of a guard time interval (G, GG), k a subcarrier index and j the number of retries of the OFDM symbols c_{m,d}(n).

Preferably the value
C(k)_{-26:26}={1,1,−1,−1,1,1,−1,1,−1,1,1,1,1,1,1,−1,−1,1,1,−1,1,−1,1,1,1,1,0, 1,−1,−1,1,1,−1,1,−1,1,−1,−1,−1,−1,−1,1,1,−1,−1,1,−1,1,−1,1,1,1,1,}
is used as the basic channel estimation signal, which provides a direct downwards compatibility of the method to 802.11 systems or stations.

The postamble structure P1 consequently makes it possible for the receive station E to determine all complex transmission factors Hₖ, mᵣ, mₜ. In accordance with FIG. 4 one variant which, although not especially efficient as regards bandwidth, is very simple for the receive station E from the standpoint of complexity, involves transmitting the channel estimation sections KA1 described previously with their respective channel estimation sequences successively, i.e. consecutively, on each transmit antenna 1 to M_{T}. In this context it is pointed out that the label shown in FIG. 4 for the transmit antennas 1 to M_{T} also applies in the same way to the receive antennas 1 to M_{R} provided a corresponding station receives the postamble structure P1. This means that the parameter M_{T} identifies both the number of transmit antennas and also the number of receive antennas in a relevant send station and M_{R} accordingly the number of transmit and receive antennas in the receive station E.

An explicit signaling of the length of the postamble P1 is not necessary. Because of the particular postamble structure it is possible relatively simply to determine the length implicitly, for example by determination of the autocorrelation function (AKF) at an interval of 64 sampling values over a time window of at least the same order of magnitude. By way of support the number of transmit antennas can also be made known in advance via an expansion of a so-called “capability information field” or other “information elements” to be defined, as provided for example within IEEE 802.11. Since the postamble P1 does not inevitably have to be appended for each RTS/CTS signaling, it is thus only necessary to record whether a postamble exists at all.

Subsequently it is further assumed that the receive station E makes a selection of the spatial own modes to be used by the send station S on the basis of channel matrices Hₖ for each subcarrier k, which are then to be used for the actual data transmission. The basic prerequisite for the applicability of this scheme is that the transmission channel is reciprocal and suitably time-invariant. A sufficient time invariance is available if the transmission properties of the channel do not change significantly from the measurement of the transmission channel through the evaluation of the channel estimation sequence up to the end of the payload data transmission.

The spatial own modes can be determined in the receive station E by an SVD, (Singular Value Decomposition) of the channel matrices
[Hₖ]_{M}_{_{R}}_{xM}_{_{T}}[Uₖ]_{M}_{_{R}}_{xM}_{_{R}}[Sₖ]_{M}_{_{R}}_{xM}_{_{T}}[Vₖ^{H}]_{M}_{_{T}}_{xM}_{_{T}}.

In this case are U and V are unitary matrices, while S exhibits a diagonal structure, the entries of which represent the attenuation values of the corresponding own modes. If
[\tilde{V}ₖ]_{M}_{_{T}}_{xD}_{ₖ}=(v_{k,1},v_{k,2}, . . . , v_{k,D}_{ₖ})
is the quantity of own modes (=preprocessing matrix) to be used by the send station S and

$$\begin{matrix}{[ {\tilde{U}}_{k}^{H} ]}_{{D}_{k} \times {M}_{R}} = {( {u}_{k , 1} , {u}_{k , 2} , … , {u}_{k , {D}_{k}} )}^{H} \\ = ( \begin{matrix}{u}_{k , 1 , 1} & {u}_{k , 1 , 2} & … & {u}_{k , 1 , {D}_{k}} \\ {u}_{k , 2 , 1} & {u}_{k , 2 , 2} & & {u}_{k , 2 , {D}_{k}} \\ ⋮ & & ⋰ & ⋮ \\ {u}_{k , {M}_{R} , 1} & {u}_{k , {M}_{R} , 2} & … & {u}_{k , {M}_{R} , {D}_{k}}\end{matrix} )\end{matrix}$$

is the associated equalization matrix in the receive station E, the following then applies for the receive vector

$$\begin{matrix}{y}_{R} = {[ {H}_{k} ]}_{{M}_{R} \times {M}_{T}} {x}_{T} \\ = {{{{{[ {\tilde{U}}_{k}^{H} ]}_{{D}_{k} \times {M}_{R}} [ {U}_{k} ]}_{{M}_{R} \times {M}_{R}} [ {S}_{k} ]}_{{M}_{R} \times {M}_{T}} [ {V}_{k}^{H} ]}_{{M}_{T} \times {M}_{T}} [ {\tilde{V}}_{k} ]}_{{M}_{T} \times {D}_{k}} {I}_{T} \\ = {[ {\tilde{S}}_{k} ]}_{{D}_{k} \times {D}_{k}} {I}_{T} ,\end{matrix}$$

with I representing the data vector and \tilde{S}ₖ the resulting diagonal channel matrix. The idea is now to construct a further postamble structure P2 so that the preprocessing is undertaken using the vectors u_{k,d*} with d=1, . . . Dₖ, with the superscripted * meaning “conjugated complex”. In relation to the diagram shown at the bottom of the page, this means in detail:
c_{m,d}(n)=DFT⁻¹{C_{m,d}(k)} mit C_{m,d}(k)=u*_{k,m,d}·C(k)

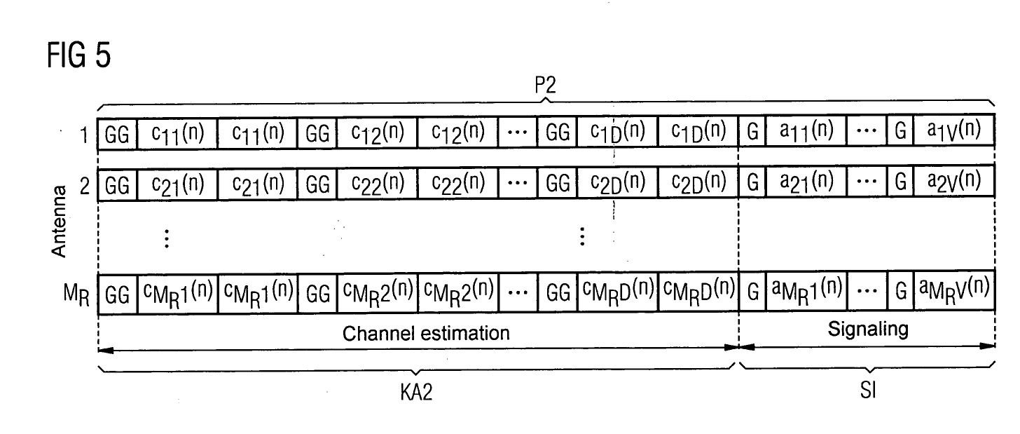

From this emerges the further postamble structure P2 shown in FIG. 5, which features a further channel estimation section KA2 with a further channel estimation sequence in accordance with

$${c}_{m} ( n ) = {g}_{m , 1} ( n ) \underbrace{{c}_{m , 1} ( n ) … {c}_{m , 1} ( n )}_{j} {g}_{m , 2} ( n ) \underbrace{{c}_{m , 2} ( n ) … {c}_{m , 2} ( n )}_{j} … {g}_{m , D} ( n ) \underbrace{{c}_{m , D} ( n ) … {c}_{m , D} ( n )}_{j}$$

and a signaling section SI for signaling the already locally determined transmission mode. For the number of sequence pairs for channel estimation the requirement D=max{Dₖ} should be adhered to.

The advantage of the preprocessing presented above lies in the fact that in the send station S the preprocessing vector v_{k,d} can be derived directly from the postpreamble components or the channel estimation sequence c_{m,d(n)}, since the following applies

$$\begin{matrix}{y}_{T , d} = {[ {H}_{k}^{T} ]}_{{M}_{T} \times {M}_{R}} {x}_{R , d} \\ = {{{[ {V}_{k}^{*} ]}_{{M}_{T} \times {M}_{T}} [ {S}_{k}^{T} ]}_{{M}_{T} \times {M}_{R}} [ {U}_{k}^{T} ]}_{{M}_{R} \times {M}_{R}} {u}_{k , d}^{*} \cdot C ( k ) \\ = {v}_{k , d}^{*} \cdot {s}_{k , d} \cdot C ( k )\end{matrix}$$

The variable S_{k,d} represents in this case the attenuation factor which is linked to the own mode u_{k,d} and represents an element of the diagonal matrix Sₖ. Simultaneously the scope of the feedback signaling is reduced, since instead of M_{R} sequence pairs for channel identification in the send station, only D sequence pairs are necessary. In conjunction with spatial multiplexing the requirement D≦min{M_{T}, M_{R}} then namely applies, with D≦min{M_{T}, M_{R}} being selected in practice.

The signaling information of the signaling section SI shown in FIG. 5 is necessary for transfer of the physical transmission parameters for the relevant own modes and thus for the respective selected transmission mode. It can be transmitted either before or after the channel component section or the further channel estimation section KA2, with the latter being shown in FIG. 5. If however it is transmitted before channel estimation section KA2, it is sensible to use the same physical transmission mode as the receive station E or the CTS. This variant also makes it possible to explicitly transmit the length of the signaling section SI as well as the length of the further channel estimation section KA2, which increases detection security.

If on the other hand the signaling section SI is transmitted after the further channel estimation section KA2 in accordance with FIG. 5, at least the length of the sequence for channel estimation is to be derived implicitly from the receiver signal. It is advantageous in this case for the identified own modes to already be able to be used for transmission of the signaling information, in which case, when spatial multiplexing is used, either transmission time is saved or the transmission security can be increased with the application of diversity methods.

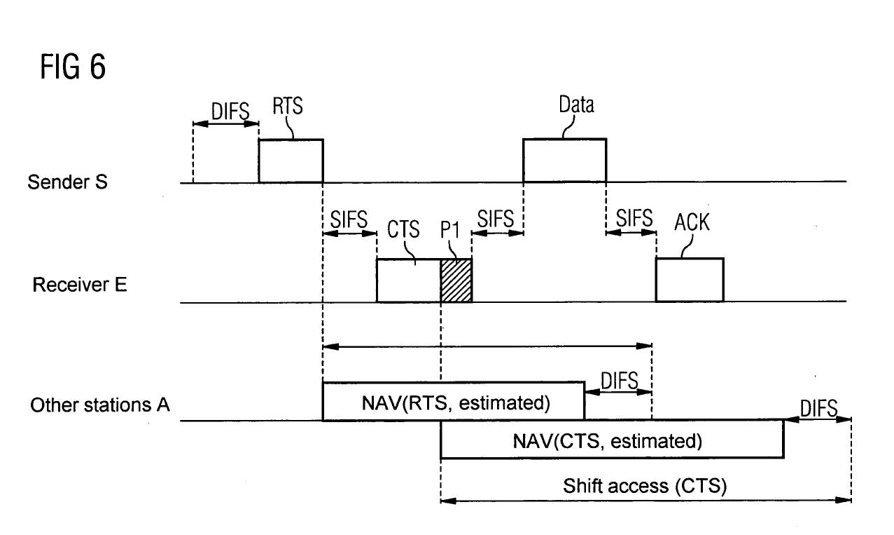

FIG. 6 shows a simplified data frame structure for an RTS/CTS data exchange to illustrate a method for realizing a link adaptation in accordance with a second exemplary embodiment, with the same reference symbols designating the same or corresponding elements or data blocks as in FIGS. 1 to 5, and subsequently not being described once again.

In accordance with FIG. 6, with a method for realizing a link adaptation according to a second exemplary embodiment, only the postamble structure P1 can be used, which significantly reduces the signaling overhead.

The main differences from the method in accordance with FIG. 2 then consist of a channel being identified exclusively on the basis of the postamble structure P1 which is immediately appended to the clear-to-send signal CTS. The send station S, and not the receive station E, consequently decides independently which transmission mode is to be employed for the payload data Data. The interference situation at the receive station E is not reciprocal and is not detected or evaluated at the send station S. If however it is assumed that interference based the CSMA/CA method used in 802.11 will be avoided in any event, this aspect does not have any role to play.

Neither with the RTS signaling nor with the CTS signaling is the duration of the data transmission according to FIG. 6 known because of the transmission mode which is still unknown at this point in time, so that the network access vector NAV of the other stations A cannot be correctly set. Estimated transmission blockage times or network access vectors NAV are produced both for the RTS and also for the CTS. It would be possible in this case in the send station to adapt the number of transmitted data bits to the selected transmission mode such that the transmission time despite this corresponds to the predicted duration of the “duration block” in the RTS, and on transfer of the value, also in the CTS.

If the clear-to-send signal CTS for preserving compatibility is transmitted over one of the M_{R} possible transmit antennas, a channel estimation sequence pair c(n) is redundant within the postamble structure P1 and can consequently be omitted, which further reduces the overhead.

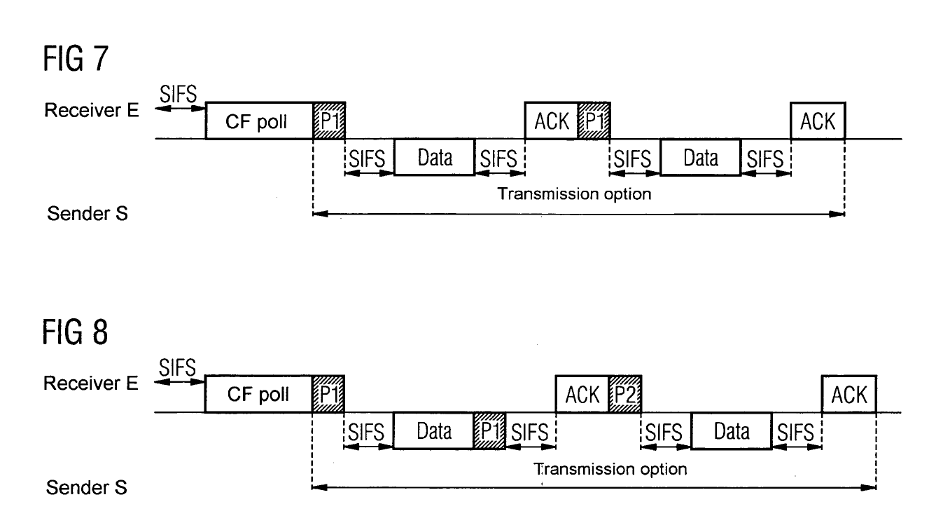

The present method for realizing a link adaptation can however not only be used in conjunction with the RTS/CTS-signaling of the 802.11 Standard, but can also be performed as shown in FIGS. 7 and 8 in conjunction with the polling mechanisms defined in the same Standard.

FIG. 7 shows a simplified data frame structure for a data polling mechanism to illustrate a method according to a third exemplary embodiment, with the same reference symbols once more identifying the same or corresponding elements as in FIGS. 1 to 6 and subsequently not being described once again.

In accordance with FIG. 7 a data block CF-POL for initializing a data polling mechanism can likewise be appended to a postamble structure P1, with a send station S again transmitting the payload data Data after an interframe space SIFS and selection of a transmission mode. If the payload data is further fragmented as in FIG. 7, i.e. transmitted in a number of blocks, and each fragment acknowledged with an acknowledgement signal ACK, then a postamble P1 appended to the acknowledgement signal ACK can also support a continuous adaptation of the transmission parameters to the transmission characteristics of the transmission channel. Depending on the time variance of the transmission channel it is if necessary sufficient in this case to only append the postamble structure P1 to every xth acknowledgement signal ACK.

FIG. 8 shows a simplified data frame structure for the data polling mechanism to illustrate a method for realizing a link adaptation in accordance with a fourth exemplary embodiment, with the same reference symbols once more identifying the same or corresponding elements or data blocks as in FIGS. 1 to 7 and subsequently not being described again.

According to FIG. 8 a combination of the method shown for example in FIGS. 2 and 6 for link adaptation in relation to a data polling mechanism is possible, with initially a selection of the transmission mode for the send station S being enabled only using the postamble structure P1. In a further section, using both the postamble structure P1 and also the postamble structure P2 comparable to the RTS/CTS data exchange according to FIG. 2, account is also taken of the transmission mode selected on the receiver side for the send station S.

The method has been described above with reference to an OFDM transmission system in accordance with the IEEE 802.11 Standard. It is however not restricted to this and also includes in the same way alternate MIMO-OFDM transmission systems.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-14. (canceled)

15. A method for realizing a link adaptation in a multiple input multiple output-orthogonal frequency division multiplexing transmission system including stations that each have a plurality of antennas, comprising:
chronologically appending at a first station a first postamble structure directly to a first data block having insufficient information for multiple input multiple output channel identification, the first postamble structure having a first channel estimation section with a first channel estimation sequence for each antenna;
sending the first data block and the first postamble structure from the first station;
receiving the first data block and the first postamble structure at a second station; and
selecting at the second station a first transmission mode for a next data block to be sent based on the first channel estimation sequence received.

16. The method as claimed in claim 15, further comprising:
chronologically appending at the second station a second postamble structure directly to a second data block, the second postamble structure based on the first channel estimation sequence of the first postamble structure and having, for each antenna, a signaling section with a signaling sequence for signaling the first transmission mode and a second channel estimation section with a second channel estimation sequence; and
sending the second data block and the second postamble structure from the second station;
receiving the second data block and the second postamble structure at the first station; and
selecting at the first station a second transmission mode based on at least one of the second channel estimation sequence and the first transmission mode.

17. The method as claimed in claim 16, wherein the first transmission mode is selected as the second transmission mode.

18. The method as claimed in claim 16, wherein said selecting of the second transmission mode includes modifying of the first transmission mode.

19. The method as claimed in claim 18, further comprising sending an identification of the second transmission mode from the first station to the second station.

20. The method as claimed in claim 19, wherein, in the second postamble structure, the signaling section is transmitted chronologically before or after the second channel estimation section.

21. The method as claimed claim 20, wherein the first channel estimation sequence cₘ(n) of the postamble structure for each antenna includes a concatenation of the orthogonal frequency division multiplexing symbols c_{m,x}(n) corresponding to
$${c}_{m} ( n ) = {g}_{m , 1} ( n ) \underbrace{{c}_{m , 1} ( n ) … {c}_{m , 1} ( n )}_{j} {g}_{m , 2} ( n ) \underbrace{{c}_{m , 2} ( n ) … {c}_{m , 2} ( n )}_{j} … {g}_{m , D} ( n ) \underbrace{{c}_{m , {M}_{T}} ( n ) … {c}_{m , {M}_{T}} ( n )}_{j}$$
$$with$$
$${c}_{m , x} ( n ) = {DFT}^{- 1} \{ {C}_{m , x} ( k ) \} und {C}_{m , x} ( k ) = \{ \begin{matrix}C ( k ) & x = m \\ 0 & sonst\end{matrix} n = 1 , … , N$$
with C(k) representing a basic channel estimation signal in a frequency range, m=1, . . . , M_{T} an antenna index, M_{T} a number of transmit antennas, x=1, . . . , M_{T} a further antenna index, n=1, . . . , N a sampling index, N a number of sampling values per orthogonal frequency division multiplexing symbol, g_{m,x}(n) a guard interval sequence of a guard time interval, k a subcarrier index and j a number of retries of the orthogonal frequency division multiplexing symbols c_{m,x}(n).

22. The method as claimed in claim 21, wherein the second channel estimation sequence cₘ(n) of the second postamble structure for each antenna includes a concatenation of the orthogonal frequency division multiplexing symbols c_{m,d}(n) corresponding to
$${c}_{m} ( n ) = {g}_{m , 1} ( n ) \underbrace{{c}_{m , 1} ( n ) … {c}_{m , 1} ( n )}_{j} {g}_{m , 2} ( n ) \underbrace{{c}_{m , 2} ( n ) … {c}_{m , 2} ( n )}_{j} … {g}_{m , D} ( n ) \underbrace{{c}_{m , D} ( n ) … {c}_{m , D} ( n )}_{j}$$
$$with$$
$${c}_{m , d} ( n ) = {DFT}^{- 1} \{ {C}_{m , d} ( k ) \} mit {C}_{m , d} ( k ) = {u}_{k , m , d}^{*} \cdot C ( k )$$
with C(k) representing a basic channel estimation signal in a frequency range, m=1, . . . , M_{R} an antenna index, M_{R} a number of receive antennas, d=1, . . . , D an index of a spatial data stream, D a maximum number of spatial data streams across all subcarriers
$$D = {max }_{∀ k} {D}_{k} ,$$
n=1, . . . , N a sampling index, N a number of sampling values per orthogonal frequency division multiplexing symbol, g_{m,d}(n) a guard interval sequence of a guard time interval, k a subcarrier index, j a number of retries of the orthogonal frequency division multiplexing symbols c_{m,d}(n) and u*_{k,m,d} a conjugated complex mth column and dth row element of a left singular matrix Uₖ.

23. The method as claimed in claim 22, wherein the guard time interval (G, GG) is formed from a single typical orthogonal frequency division multiplexing guard interval sequence
g_{m,d}(n)=c_{m,d}(n+N−N_{G}) n=1, . . . , N_{G}
or from a double typical orthogonal frequency division multiplexing guard interval sequence
g_{m,d}(n)=c_{m,d}(n+N−2N_{G}) n=1, . . . , 2N_{G},
with N_{G} representing the number of sampling values of the guard time interval.

24. The method as claimed in claim 23, wherein the basic channel estimation signal satisfies
C(k)_{-26:26}={1,1,−1,−1,1,1,−1,1,−1,1,1,1,1,1,1,−1,−1,1,1,−1,1,−1,1,1,1,1,0, 1,−1,−1,1,1,−1,1,−1,1,−1,−1,−1,−1,−1,1,1,−1,−1,1,−1,1,−1,1,1,1,1,}

25. The method as claimed in claim 24, wherein at least one of the first and second data blocks represents one of a ready to send signal, a clear to send signal, an acknowledgement signal, a payload data signal and a data polling signal.

26. The method as claimed in claim 25, wherein each of said sending operations uses a transmission channel that is reciprocal and substantially time-invariant.

27. The method as claimed in claim 26, wherein the orthogonal frequency division multiplexing transmission system meets an IEEE 802.11 standard.

28. The method as claimed in claim 27, wherein each of said sending operations uses a decentrally organized carrier sense multiple access system utilizing one of RTS/CTS signaling and a data polling mechanism.
